(19) United States
(12) Patent Application Publication
(10) Pub. No.: US 2005/0121431 A1
(43) Pub. Date: Jun. 9, 2005

(54) Micro computer thermal mug

(76) Inventor: Se Kit Yuen, Hong Kong (CN)

Correspondence Address: ARTHUR KING MA, 1030 CORONADO DRIVE, ARCADIA, CA, 91007, US

(21) Appl. No.: 10/728,421

(22) Filed: Dec. 5, 2003

(51) Int. Cl. A21B 1/52; F27D 11/00

(52) U.S. Cl. 219/387

(57) ABSTRACT

Said hand-held thermal mug has an inlet on said top, above which there is a rotating cover, in which there is an outlet and a rotating opening. Said opening can seal said outlet of said rotating cover when it is rotated. After filling said hand-held thermal mug with water, said consumer can cover up said mug using said rotating cover to seal and prevent water in said mug from spilling out, or turn rotating cover till said outlet and said inlet coincide. Said thermal mug has an external low-voltage electric socket, which can be connected to automotive power. Said power supplies to said temperature control device in said front of said hand-held thermal mug. Said device consists of an automatic thermometer that indicates said temperature inside said container, a switch and four temperature indicating lights. Said consumer can freely adjust said temperature of said water inside said mug to preferred level. Said mug can also maintain said temperature of said water inside, and provide proper water temperature for said consumer. Said thermal mug is designed to fit mug trays in automobiles and vessels for said convenience of said driver. Said consumer can put any preferred beverages into said hand-held shatterproof thermal mug, and drink at set temperature at any time. This invention best serves said needs of drivers while driving, and also meets needs of daily life and office usages.

### BACKGROUND OF SAID PRESENT INVENTION

1. Field of said Present Invention

Said present invention is relates to a thermal mug, and more particularly to a microcomputer thermal mug not only for all forms of transportation medias but also for both indoor and outdoor use, so as to maintain beverage in a predetermined temperature by means of automatic turn on and shut off mechanism, automatic temperature controller, temperature indicator and power supply circuit.

2. Description of Related Arts

Thermal mugs are very typical beverage containers and are very popular for all walks of lives. Especially, they are very common for drivers who need to remain awake during long distance driving. They are also help to keep drivers warm during winter at driving when beverages are kept and consumed. However, conventional thermal containers are having many limitations, which improvements are still needed. For instances, beverages' temperature are normally hard to keep for an extended period of time. If one is located at a place, where is snowing during winter season, said temperature of beverages contained inside of those thermal containers will be dropped very soon, in most cases, those containers cannot keep warm at all.

Moreover, since there is no indicator of temperature level was affixed onto said conventional thermal containers, consumers have no way to foresee said temperature of beverages inside said container. For instance, U.S. Pat. No. 5,243,684 (Edwards) discloses a portable electrically heated container for liquids having a heating element secured to a bottom portion of said container by a support bar having its ends frictionally inserted into support slots. A base cap separable from said container for providing access to said heating element encloses said bottom of said container. Said heated container includes a power connection within said separable base cap and indicating light to show a power-on condition. Consumers, in most cases, however, would never know what said temperature that said beverage is. Therefore, they need to use their lips as thermostats to test said temperature of said beverage every time when they have to drink said beverage from those conventional thermal containers. Consumers always hurt their lips simply because they do not sure said temperature of said beverages.

Another limitation that those conventional thermal containers are encountering is said level of warmness cannot be personalized or cannot be adjusted. Although there are some thermal containers have abilities to keep hot beverages warm for an extended period of time, for example, U.S. Pat. No. 6,140,614 (Padamsee) discloses an electric drinking cup for use while driving a vehicle. Said electric drinking cup includes a plastic inner liner, a metal outer shell, and an insulation-filled space there between. A heating element is associated with said bottom portion of said inner liner, and is electrically connected to a vehicle's electrical system. Said plastic inner liner curves around said upper edge of said outer metal shell providing a cup lip that does not get too hot when said cup contains a liquid. Said combination of said plastic inner shell and said heating element provides a diffuse heat that heats liquid, such as coffee or hot chocolate, slowly to said desired temperature so that said liquid does not burn and become distasteful. However, due to personal preferences or said nature of said beverages, consumers might find that not all of said beverages can be kept in a universal level of temperature. For example, fresh grounded and brewed coffee without cream and sugar should kept at least 5 to 8° C. lower than an instant coffee in order to have said best tastes while chicken soup should be kept at least 90° C.

There is a thermal container available, which has a set of power supply and allows electricity to warm up said container in order to keep beverage warm so long as said power supply is plugged. For instance, U.S. Pat. No. 5,508,494 (Sarris et al.) reveals a portable beverage cup made of thermally and electrically insulated material, such as injection molded plastic having a low melting point. Said beverage cup includes a heating element that warms said beverage and a retractable power cord that passes through an aperture in said container shell and is wound around said out surface of said container in a helical manner. However, limitation for this kind of thermal container is it cannot keep a predetermined temperature in a safe and satisfactory manner. Since it does not have any mechanism to control said power supply nor to control any predetermined temperature, it most likely either over-heats said beverage or said temperature is not satisfied to said consumer. In some extremely cases, fires were encountered since said container was not only over-heated said beverage but also melted said wiring and bottom portion of said container which allow electricity shocks which ultimately leaded to fires.

### SUMMARY OF SAID PRESENT INVENTION

A main object of said present invention is to provide a hand held thermal mug which is adapted for to keep beverage with a predetermined temperature for an extend period of time.

Another object of said present invention is to provide a hand held thermal mug which is adapted for to provide a thermostat with a LCD display which indicate temperature of said beverage so that consumer can tell said temperature of said beverage contained within said thermal mug.

Another object of said present invention is to provide a hand held thermal mug which is adapted for to provide ability for consumer to adjust said level of temperature of beverage contained as desired by consumer.

Another object of said present invention is to provide a hand held thermal mug which is adapted for to provide an automatic temperature control device, which will switch off said power supply when a predetermined level of temperature is reached.

Accordingly, in order to accomplish said above objects, said present invention provides a hand held thermal mug for vehicles, comprising:

a high-temperature shatter-proof plastic container, a handle with predetermined size and sharp, an rotating filling container with at least an opening on top portion, a plurality of rotating covers with predetermined sharps and an opening on it, an external electric socket, and an automatic temperature control device. Said handle is integrally connected to said container.

There is a contact metal at center part of bottom portion of said rotating filling container. Said heating device and said automatic temperature control device at said center part of bottom portion of said container make contact with said contact metal at said center part of bottom portion of said rotating filling container to convey heat, and increase said temperature of said beverage contained inside said rotating filling container. When it reaches a temperature specified by consumer, a thermal device will stop generating heat; but when said temperature of said beverage inside said filling container decreases, said thermal device will automatically activate heating device to give out heat again, until said beverage temperature reaches a predetermined level. This is a circulating process.

There is an outlet connected to said rotating cover. Consumer may turn said rotating cover to release beverage from said outlet, or to seal said outlet. Said rotating cover is on top portion of said container.

Said external electric socket is integrally connected to said container.

Said automatic temperature control device is integrally connected to surface of said container. There is a liquid crystal display (LCD) board on it to adjust and indicate temperature.

This invention of hand-held Thermal mug provides hot beverages for driving consumers under all environments. Even long-time automotive driver can enjoy beverages, such as coffee or tea, etc. at desired temperature.

### BRIEF DESCRIPTION OF SAID DRAWINGS

FIG. 1 is a partially enlarged sectional view of the present invention.

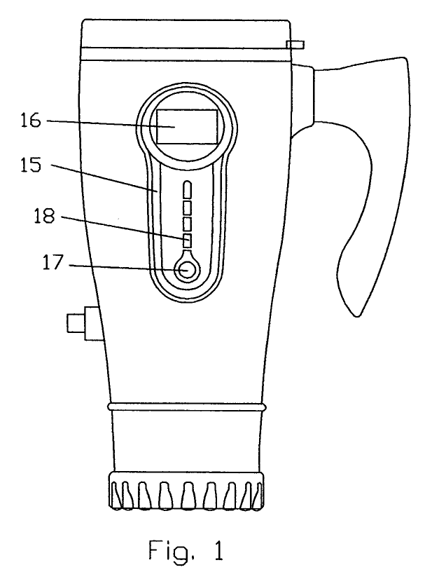

FIG. 2 is a perspective view of the present invention.

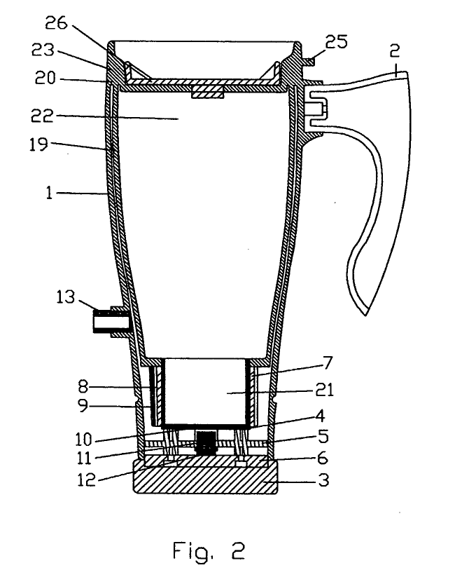

FIG. 3 is a top view of the present invention.

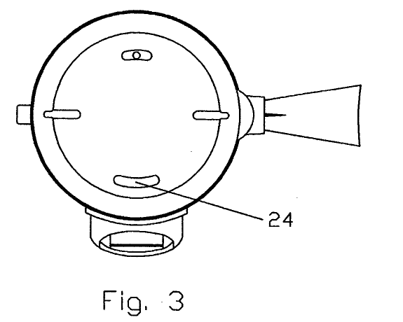

FIG. 4 is a front View of the present invention.

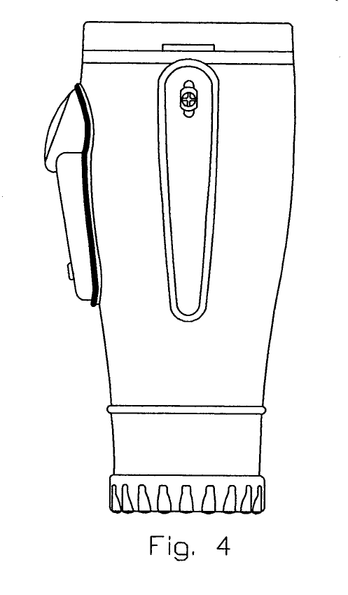

FIG. 5 is a rear View of the present invention.

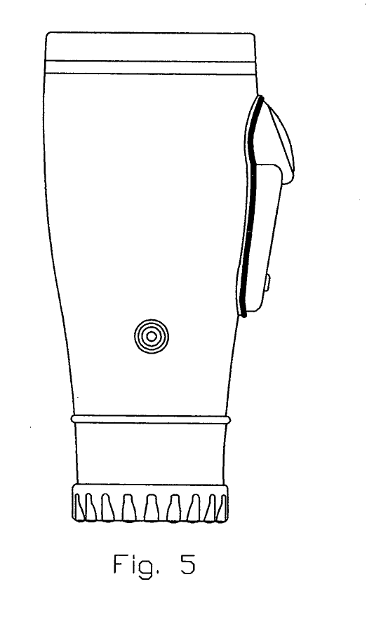

FIG. 6 is a bottom view of the present invention.

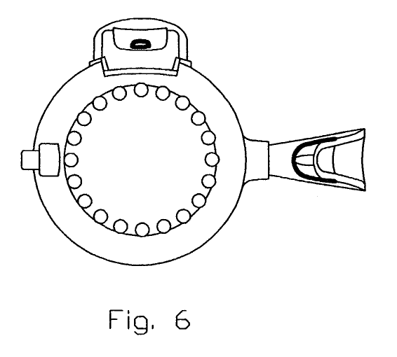

### DETAILED DESCRIPTION OF SAID PREFERRED EMBODIMENT

This invention of hand-held thermal mug consists of a cylinder container (1), which is integrally connected with a handle with predetermined size and sharp (2) at said side. There is a lower cap (3) made of flexible material at said bottom of said container (1) that provides a horizontal support for said container (1). At said bottom of said container (1), a metal temperature monitor (8) is integrally connected to a heating wire (7), both of which are bound to outer surface of a heating component (4) by a high-temperature wire (9). In said center of a fixed mount (5), there is a round hole (10) to locate said temperature detector (11). A spring (12) underneath temperature detector (11) ensures said fixed mount moves in said center hole (10) of said fixed mount (5).

On other side of said container (1), there is an external electric socket (13), from where said heating wire passes bottom portion of said fixed mount (5) and connects to a circuit board (14). It is through said bottom portion of said fixed mount (5) that said connecting line of heating wire (7); said temperature detector (11) and said temperature monitor (8) are connected to said circuit board (14). Said aforesaid circuitboard (14) is fixed inside a control panel (15). Said circuit board (14) is amini computer, where a series of logic programs are inserted inside on said control panel (15) form an integral circuit. Said control panel (15) connects to a displayer (16). On said panel (15), are also a switch (17) and four temperature indicating lights (18).

This invention of hand-held said thermal mug consists of a cylinder filling container (19). Said is a sealing washer (20) on top portion of said filling container (19). Said is a metal heat-transfer component (21) at bottom portion of said filling container (19). Said filling container (19) can provide rotating motions and put in center portion of said container (1). Said heat-transfer component (21) at bottom portion of said container (19) is accessible to said heating component (4) and said temperature detector (11). There is an inlet (22) on top portion of said filling container (19). Said inlet (22) is sealed to prevent t spilling or outflow of beverages inside said filling container (19). There is also an outlet (24) on top surface and said sealing washer (25) at said bottom surface of said cover (23). Said top of said cover (23) can provide rotating motions so as to overlap a rotating inlet (26), which can seal said outlet (24) on said cover (23).

Consumer first pours said preferred beverage into said filling container (19), seals said filling container (19) with said cover (23), said seals said inlet (22) of said filling container (19) with said cover. Said consumer can said choose and specify proper temperature for said beverage by adjusting said switch (17) on said control panel (15). Said specified temperature will be indicated on said displayer (16), and said chosen temperature indicating light (18) is also turned on. At this time, said temperature monitor (8) on said fixed mount (5) of said container (1) is connected to said heat-transfer component (21) under said filling container (19), so it reflects said temperature of said beverage inside said filling container (19). If said temperature is lower than specified by said consumer, said circuit board (14) will automatically convey heat of said heating component (4) of said container (1) to said heating component (21) of said filling container (19), thus heat said beverage inside said filling container (19) till it reaches said temperature as specified by said consumer. When said temperature monitor (18) senses that said temperature has reached said level as specified by said consumer, said temperature monitor (11) will automatically break off, and said heating wire (7) will stop generating heat. When said temperature monitor (11) senses that said temperature is 3 degrees lower than that specified, it will automatically activate heating wire. It is obvious that through such circulating work, said temperature of said beverage inside said filling container (19) can be maintained at specified level, so that said consumer can enjoy beverages at desired temperature under any environment at any time.

1. A high-temperature shatter-proof thermal mug comprising:
a handle with predetermined size and sharp integrally connected said plastic container;
a rotating filling container with at least an opening on top portion;
a plurality of rotating covers with predetermined sharps and an opening on it is outwardly extended of said rotating filling container;
a heating component with heating wire connecting temperature monitor, and temperature detector, said heating wire surrounds said heating component, said temperature detector is next to heating wire, and said temperature monitor is on said center part bottom portion of said heating component, and
an external electric socket which is permanently united with an automatic temperature control device and a plurality of indicating lights are attached on the top of said filling container thereof.

2. A thermal mug, as recited in claim 1, said thermal mug contact metal at center part of bottom portion of said rotating filling container. Said heating device and said automatic temperature control device at said center part of bottom portion of said container make contact with said contact metal at said center part of bottom portion of said rotating filling container to convey heat, and increase said temperature of said beverage contained inside said rotating filling container. When it reaches a temperature specified by consumer, a thermal device will stop generating heat; but when said temperature of said beverage inside said filling container decreases, said thermal device will automatically activate heating device to give out heat again, until said beverage temperature reaches a predetermined level.

3. A thermal mug, as recited in claim 1, there is an outlet connected to said rotating cover. Consumer may turn said rotating cover to release beverage from said outlet, or to seal said outlet. Said rotating cover is on top portion of said container.

4. A thermal mug, as recited in claim 1, said d automatic temperature control device is integrally connected to surface of said container. There is a liquid crystal display (LCD) board on it to adjust and indicate temperature.

6. A thermal mug, as recited in claim 1, said external electric socket is integrally connected to said container.

7. A thermal mug, as recited in claim 1, said control panel is characterized by fact that it can indicate temperatures within four different ranges. Control penal provide means of temperature adjustment, and then said displayer will indicate said specified temperature, and said indicating light within which said temperature will lighted up.

8. A thermal mug, as recited in claim 1, said filling container and cover can provide rotating motions so as to provide connecting and/or sealing result to said container.

9. A thermal mug, as recited in claim 1, said filling container is characterized by said heat-transfer component at said bottom of said container which conveys heat through said heating component of said container to increase said temperature of said beverage in said filling container.

10. A thermal mug, as recited in claim 1, said cover is characterized by said cover has an outlet and an opening. Said opening can seal outlet of said cover when it rotates.

11. A thermal mug, as recited in claim 1, said container, which is integrally connected with a handle with predetermined size and sharp at said side. There is a lower cap made of flexible material at said bottom of said container that provides a horizontal support for said container. At said bottom of said container, a metal temperature monitor is integrally connected to a heating wire, both of which are bound to outer surface of a heating component by a high-temperature wire. In said center of a fixed mount, there is a round hole to locate said temperature detector. A spring underneath temperature detector ensures said fixed mount moves in said center hole of said fixed mount.

12. As recited in claim 1, there is an external electric socket located of side of said container from where said heating wire passes bottom portion of said fixed mount and connects to a circuit board. It is through said bottom portion of said fixed mount that said connecting line of heating wire; said temperature detector and said temperature monitor are connected to said circuit board. Said aforesaid circuit board is fixed inside a control panel.

13. As recited in claim 1, said container contains a circuit board, which is a mini computer, where a series of logic programs are inserted inside on said control panel form an integral circuit. Said control panel connects to a displayer. On said panel, there are also a switch and four temperature indicating lights.

14. As recited in claim 1, said thermal mug consists of a cylinder filling container. There is a sealing washer on top portion of said filling container. There is a metal heat-transfer component at bottom portion of said filling container. Said filling container can provide rotating motions and put in center portion of said container. Said heat-transfer component at bottom portion of said container is accessible to said heating component and said temperature detector. There is an inlet on top portion of said filling container. Said inlet is sealed to prevent t spilling or outflow of beverages inside said filling container. There is also an outlet on top surface and said sealing washer at said bottom surface of said cover. Said top of said cover can provide rotating motions so as to overlap a rotating inlet, which can seal said outlet on said cover.

14. As recited in claim 12, said container contains a circuit board, which is a mini computer, where a series of logic programs are inserted inside on said control panel form an integral circuit. Said control panel connects to a displayer. On said panel, there are also a switch and four temperature indicating lights.

15. As recited in claim 13, said container contains a circuit board, which is amini computer, where a series of logic programs are inserted inside on said control panel form an integral circuit. Said control panel connects to a displayer. On said panel, there are also a switch and four temperature indicating lights.
